(19) United States
(12) Patent Application Publication
(10) Pub. No.: US 2023/0344288 A1
(43) Pub. Date: Oct. 26, 2023

(54) LAMINATION OF A LAMINATED CORE, AND ROTOR OF AN ELECTRIC ROTATING MACHINE HAVING A PLURALITY OF LAMINATIONS

(71) Applicant: Schaeffler Technologies AG & Co. KG, Herzogenaurach (DE)

(72) Inventors: Florian Nachtmann, La Wantzenau (FR); Jochen Kinzig, Malsch (DE); Sebastien Heitz, Niederschaeffolsheim (FR)

(73) Assignee: Schaeffler Technologies AG & Co. KG, Herzogenaurach (DE)

(21) Appl. No.: 17/913,887

(22) PCT Filed: Mar. 10, 2021
(86) PCT No.: PCT/DE2021/100248

§ 371 Date: Sep. 23, 2022

(30) Foreign Application Priority Data
Mar. 31, 2020 (DE) 10 2020 108 830.2

(51) Int. Cl. H02K 1/276

(52) U.S. Cl. CPC H02K 1/276

(57) ABSTRACT

A lamination of a laminated core of a rotor of an electric rotating machine includes; body, a plurality of first sectors, and a plurality of second sectors. The body has a ring shaped defined by an inner radial side and an outer radial side. The plurality of first sectors extend from the inner radial side to the outer radial side. The plurality of second sectors extend from the inner radial side to the outer radial side. A radial compressive strength of the plurality of first sectors, at least at the inner radial side is greater than a radial com pressive strength of the plurality of second sectors at the inner radial side.

### CROSS-REFERENCE TO RELATED APPLICATIONS

This application is the U.S. National Phase of PCT Appln. No. PCT/DE2021/100248 filed Mar. 10, 2021, which claims priority to DE 102020108830.2 filed Mar. 31, 2020, the entire disclosures of which are incorporated by reference herein.

### TECHNICAL FIELD

The disclosure relates to a lamination of a laminated core and to a rotor of an electric rotating machine having a plurality of said laminations.

### BACKGROUND

Rotors of permanently excited synchronous machines, which have magnets on their radial outsides, which are arranged in pocket-like recesses in the rotor or in a stack of laminations composed of laminations, are known.

Radial inner areas of these laminations are arranged on a respective rotor shaft. To transmit torque from the rotor shaft to the laminations or in the opposite direction, torque transmission devices that act in a form-fitting manner are often used, such as lugs on the laminations that engage in a groove in the rotor shaft.

To facilitate assembly of the laminations, the laminations often sit on the rotor shaft with a clearance fit.

In a central radial area of the laminations, the laminations may have recesses to reduce the mass or the mass moment of inertia. These recesses are evenly distributed over the circumference.

Due to the high masses of the magnets arranged on the radial outside, an imbalance can occur in the rotor, particularly during dynamic events such as speed impacts, speed changes, engagement of a parking lock, etc. This imbalance is equivalent to a wandering movement or displacement of the stack of laminations. Even devices for axial biasing, such as a central screw in the rotor shaft, cannot always reliably counteract such displacements or imbalances.

The resulting imbalances may exceed the forces permitted by the standard or the usual requirements of automobile manufacturers. In addition to the signs of wear associated with the imbalances, disruptive noise emissions are also frequently observed.

At high rotor speeds, severe deformations can occur in the radial inner area of the laminations. These radial deformations must be taken into account when designing the inner diameter of the laminations. This usually leads to strong overlaps with the rotor shaft diameter and accordingly to an interference fit over almost the entire circumference of the rotor shaft mount of the lamination in question. However, this interference fit leads to significantly higher frictional forces that have to be overcome during assembly, or to significantly higher wear and/or energy consumption, such as during warm-up, when the assembly is carried out.

### SUMMARY

It is desirable to provide a lamination of a laminated core of a rotor of an electric rotating machine and the rotor itself, wherein the lamination in the laminated core has a low tendency to produce imbalances and can be assembled in a simplified manner.

The features of the claims may be combined in any technically useful way, including the explanations from the following description and features from the figures which comprise additional embodiments of the disclosure.

The disclosure, according to one exemplary embodiment, relates to a lamination of a laminated core of a rotor of an electric rotating machine, which lamination substantially has a circular ring shape, wherein the lamination has a plurality of first sectors having, at least on a radial inside, higher radial compressive strength, and a plurality of second sectors having, at least on the radial inside, lower radial compressive strength. The lamination is thus a lamination of a so-called stack of a rotor of an electric rotating machine.

In the context of the present disclosure, the terms “radial” and “circumferential direction” always refer to the axis of rotation of the lamination or the rotor equipped with it.

Due to the design of the rotor or the lamination as a hollow cylinder or as a circular ring, each sector is a circular ring sector, wherein the centers of the first and second sectors lie in the center of the circular ring. Accordingly, each sector has the shape of an angular surface with a blank at the center. In this case, the lamination can have small deviations in shape from the circular ring shape both on the radial inside of the circular ring and on a radial outside of the circular ring.

According to the disclosure, the compressive strength of a first sector on its radial inside is greater than the compressive strength of a second sector on its radial inside.

The compressive strength significant here is the strength of the respective “sector” on the radial inside under radial pressure with regard to its yield point, i.e., with regard to elastic deformability.

In particular, it is provided that the lamination has an equal number of first sectors and second sectors. The first sectors and the second sectors should be arranged alternately in the circumferential direction.

The first sectors, which have a greater radial compressive strength, ensure that essentially no radial displacement in relation to a rotor axis and accordingly no imbalance can occur, even with higher loads on the lamination during operation of the rotor. Due to the fact that the radial inside of the lamination is not completely formed by the first sectors, but by first sectors and second sectors and thus by sections of higher radial strength and lower radial strength, assembly of the lamination and correspondingly also a laminated core with several such lamination on a shaft is possible with less installation effort or lower forces and/or lower energy input.

In an embodiment, it is provided that in a first sector, on its radial inside, a projection pointing radially inwards is arranged for abutment against the outside of a shaft. Accordingly, this means that the lamination has the smallest radial width in the areas of greatest radial compressive strength, delimited by a respective projection, in the inner area. Such a projection can also be referred to as a centering cam.

An alternative embodiment provides that the radial inside of the annular lamination is delimited essentially in the shape of a polygon, wherein the polygon has rounded corners and/or convex sides.

In particular, a respective corner area of the polygon can be located in a respective first sector. This means that the radial inside of the lamination or its circular ring shape is designed to be most pressure-resistant in the radial direction where a corner or a corner area of the polygon of the cross-sectional area of the central opening of the circular ring is located.

In an embodiment, the polygon can essentially have a triangular shape. In particular, the polygon can be designed in the form of an equilateral triangle. This triangle can be rounded with regard to its corners as well as its sides, resulting in an equilateral triangle rounded at its corners or a Reuleaux triangle rounded at its corners.

In the case of a triangle as a polygon, which is designed as a rounded equilateral triangle or rounded Reuleaux triangle, there are only three first sectors in which the corner areas of the triangle are arranged. These three first sectors are arranged alternately on the circumference with three second sectors, in which in turn the central areas of the three sides of the triangle are arranged.

The required overlapping of the polygonal profile with the shaft is significantly reduced by the relief pattern thus realized. The advantage is lower assembly forces or lower joining temperatures or higher tolerable speeds compared to a rotor lamination without such a relief pattern.

For the purpose of pressure distribution, a first window is arranged in the first sector between a first radius and a second radius that is larger than the first radius. This first window is also referred to as the radially inner window. This first window may be elongate and axisymmetric with rounded corners. A side of the first window that faces the center of the annular shape of the lamination can lie on an arc of a circle with the first radius.

The side of the first window facing away from the center of the circular ring shape of the sheet may, at least in the central area, lie substantially on an arc of a circle, the center of which corresponds to the point of intersection of the radially inner edge of the circular ring with a straight line radially extending from the center of the circular ring shape and on which the first window is mirrored.

Two elongate windows can be arranged in the second sector, which are arranged between a third radius and a fourth radius, which is larger than the third radius, and which are arranged axisymmetric to a bisecting line of the second sector.

The lamination can also be designed in such a way that a respective elongate window extends in areas from the second sector into the first sector. In an embodiment, the third radius is larger than the second radius.

Furthermore, these elongate windows can also each essentially have a triangular shape with rounded corners, in which case the sides facing the center of the circular ring shape of the lamination can also lie on arcs of a circle which essentially have the third radius. This triangular shape can be designed as an isosceles triangle, wherein the longest side of the triangle is the side facing the center of the annular shape.

Furthermore, an outer window can be arranged in the second sector on the bisecting line of the second sector between a fifth radius and a sixth radius which is larger than the fifth radius. In particular, the fifth radius can be smaller than the fourth radius.

The bisecting line of the second sector can be a mirror axis of the axisymmetric design of the outer window.

On its side facing away from the center of the circular ring shape of the lamination, the outer window can lie on an arc of a circle, at least in the central area, the radius of which essentially corresponds to the sixth radius. Starting from this circular arc, the outer window can be delimited on its side facing the center of the circular ring shape by limiting straight lines which extend axisymmetric to the bisecting line and which intersect on the bisecting line.

A respective window is to be understood as meaning a recess or through opening in the lamination.

In particular, it is provided that the outer window is arranged equidistant to the two elongate windows, wherein linear elements of the lamination are formed between the outer window and the two elongate windows of a respective second sector, which are also referred to as torque struts. These linear elements can extend at an angle of 65° to 75°, in particular at an angle of 69° to 72°, in relation to the bisecting line of the second sector.

In a further embodiment of the lamination, it is provided that the angle of the second sector is 1.5 to 2.5 times as large as the angle of the first sector.

In particular, the angle of the first sector can be 30° and the angle of the second sector can be 60°, wherein the lamination comprises a total of four first sectors and four second sectors.

In an alternative embodiment, the angle of the first sector is 30° and the angle of the second sector is 90°, wherein the lamination comprises a total of 3 first sectors and 3 second sectors.

In the second sector, there are torque transmission features in the form of at least one tooth or lug which can engage correspondingly formed complementary features of the shaft for the purpose of transmitting torque from the rotor to the shaft or vice versa. On the outside of the lamination, this advantageously has pockets for receiving magnets, so that corresponding magnets can be accommodated on the radial outside of a laminated core formed by a large number of laminations.

A tooth or a lug is arranged in particular in a second sector at its radially inner delimiting area. In the case of an essentially radial extension of such a tooth or lug, radial expansions in the second sector are irrelevant with regard to ensuring the transmission of the torque.

The windows mentioned result in a recurring pattern in the lamination in the circumferential direction. This recurring pattern or relief pattern makes it possible to transmit very high torques with small shaft diameters and short axial lengths without backlash, even at very high speeds.

A further aspect of the present disclosure is a rotor of an electric rotating machine, which has a plurality of laminations according to the disclosure arranged in a stacked manner in a laminated core and arranged coaxially to an axis of rotation of the shaft of the electric rotating machine.

The radially inner edge of the second sector can form an interference fit or a clearance fit with the shaft.

There may be an interference fit between a respective first sector and the shaft, so that no imbalance can occur during operation of the rotor. This interference fit should be within the following tolerances: H7/r6 to H7/x8. With a nominal diameter of the shaft of 55 mm, the overlap between the shaft and the radially inner limit of the lamination can be 50-150 µm.

In the embodiment of the lamination in which a radially inwardly directed projection is arranged in a first sector on its radial inside, the radial inside of this projection forms the interference fit with the shaft.

In the embodiment of the lamination in which the radial inside of the annular lamination is delimited essentially in the shape of a polygon, a corner area of the polygon forms the interference fit with the shaft. In an alternative embodiment, the interference fit is realized through the entire polygon shape.

In this embodiment, it is also provided that the cross-sectional area of the shaft, on which the lamination in question or a correspondingly shaped laminated core is seated, also has a polygon shape, which corresponds in terms of its size to a scaling of the polygon shape of the central area of the lamination.

In particular, the number of second sectors can correspond to the number of pole pairs of the rotor.

### BRIEF DESCRIPTION OF THE DRAWINGS

The disclosure described above is explained in detail below based on the significant technical background with reference to the associated drawings, which show preferred embodiments. The disclosure is in no way restricted by the purely schematic drawings, wherein it should be noted that the exemplary embodiments shown in the drawings are not limited to the dimensions shown. In the figures:

FIG. 1 shows a lamination according to the disclosure of a first embodiment in a front view,

FIG. 2: shows the lamination shown in FIG. 1 in a side view,

FIG. 3: shows a lamination according to the disclosure of a second embodiment in a front view, and

FIG. 4: shows the lamination shown in FIG. 3 in a side view.

### DETAILED DESCRIPTION

It can be seen from FIGS. 2 and 4 that the lamination 1 is configured essentially in two dimensions.

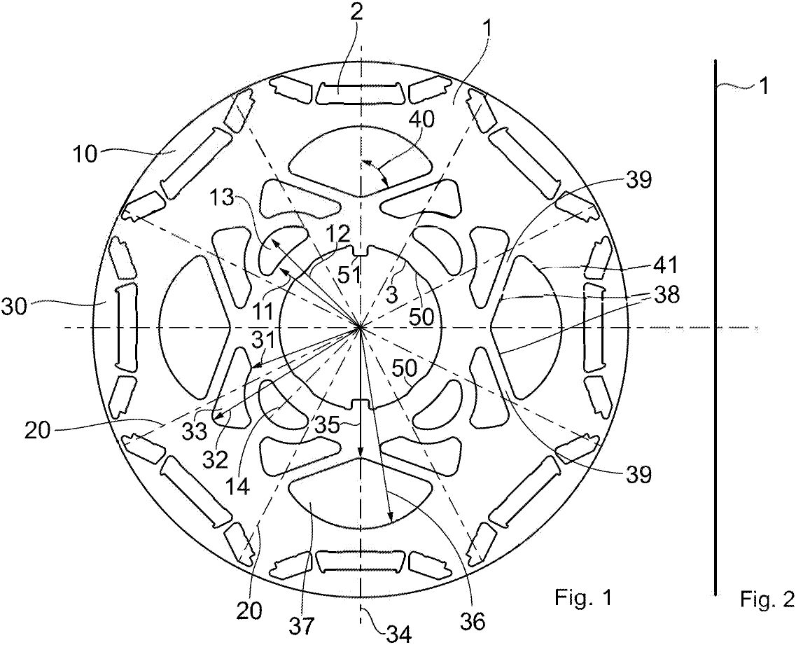

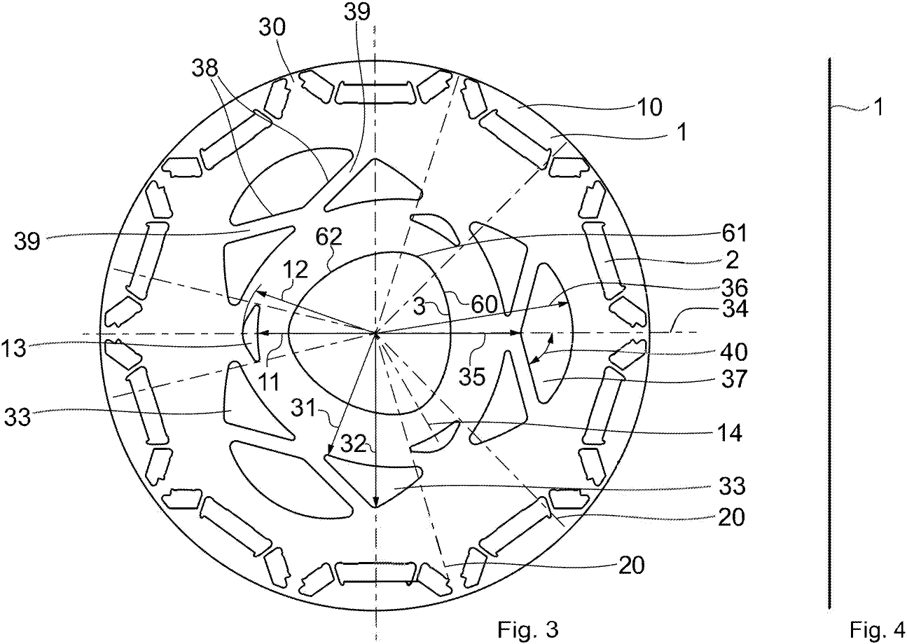

In the two embodiments of the lamination 1 shown in FIGS. 1 and 3, it has pockets 2 distributed around a circumference on its radial outside, which accommodate magnets. The embodiment variants of the lamination 1 shown in FIGS. 1 and 3 differ in the design of their respective radial inside 3. In the variant shown in FIG. 1, the lamination 1 has projections 50 directed radially inwards on its radial inside 3. Furthermore, lugs 51 are arranged offset by 180° on the radial inside 3 and engage in grooves of a shaft of a rotor (not shown here), which has the respective laminate 1 bundled together with other laminates in laminated cores. The lugs 51 are used to transmit a torque from the lamination 1 to the shaft or in the opposite direction.

The projections 50 are adapted to abut against the radial outside of the shaft with an interference fit.

The projections 50 are also referred to as centering cams.

In the embodiment shown in FIG. 3, a torque is transmitted from the lamination 1 to the shaft or in the opposite direction in a form-fitting manner due to the shape of a polygon 60 which forms the radial inside 3.

The lamination 1 is divided into a plurality of first sectors 10 and a plurality of second sectors 30, wherein the first sectors 10 and the second sectors 30 are arranged in an alternating manner on the circumference.

FIG. 1 shows an embodiment which has four first sectors 10 and four second sectors 30.

FIG. 3 shows an embodiment which has three first sectors 10 and three second sectors 30. The respective first sectors 10 and second sectors 30 are separated from one another by transition areas 20.

A first window 13 is arranged in a respective first sector 10 and essentially has the shape of a segment of a circle. A side of the first window 13 facing the center of the lamination 1 lies on a first radius 11. A point of the first window 13 that is at the maximum radial distance from the center of the lamination 1 is located on a second radius 12. In the embodiment shown, the first window 13 is mirror-symmetrical with respect to a straight line 14 which represents the bisecting line of the first sector 10.

In the second sector 30 there are two elongate windows 33. In the embodiment shown in FIG. 1, these elongate windows 33 overlap the transition area 20, so that they protrude into the respective adjacent first sector 10.

In the embodiment shown in FIG. 3, the elongate windows 33 also project into the respective adjacent first sector 10, but to a lesser extent than in the embodiment shown in FIG. 1.

With respect to a bisecting line 34 of the second sector 30, the two elongate windows 33 are arranged mirror-symmetrically. A radially innermost point of each elongate window 33 is located on a third radius 31. A radially outermost point of each elongate window 33 is located on a fourth radius 32. In the embodiment shown in FIG. 1, the third radius 31 is smaller than the second radius 12, but larger than the first radius 11. In the embodiment shown in FIG. 3, the fourth radius 32 is larger than the second radius 12.

An outer window 37 is arranged in a respective second sector 30 with mirror symmetry to the bisecting line 34 of the second sector 30. This is delimited by two delimiting straight lines 38 on its side facing the center of the lamination 1. The intersection of the two delimiting straight lines 38 lies on the respective bisecting line 34 of the second sector 30 in question and on a fifth radius 35. A radial outside of each outer window 37 is bounded by a respective arc 41 whose radially outermost point lies on a sixth radius 36.

In both illustrated embodiments, the fifth radius 35 is smaller than the fourth radius 32, but larger than the third radius 31.

Corresponding torque struts 39 are formed between a respective outer window 37 and the two elongate windows 33 of a respective second sector 30, which extend at an angle 40 of approximately 70° to the bisecting line 34. The torque is transmitted from the magnets in the pockets 2 to the shaft or vice versa by means of these torque struts 39.

In the embodiment shown in FIG. 3, the radially inner area 3 is designed as a polygon 60, wherein this polygon 60 essentially has the shape of an equilateral triangle, with rounded corners 61 and convex sides 62, so that overall a so-called Reuleaux triangle is formed.

The illustrated embodiments have in common that the lamination 1 has a relief pattern that repeats itself on the circumference, with radially inner first windows 13 in a respective first sector 10, on the radial inside of which the lamination 1 has a higher compressive strength than on the radial inside of the second sectors 30. This means that the lamination 1 with the first sectors 10 can be pulled onto a shaft with an interference fit, wherein the second sectors 30, which have a reduced compressive strength, can be expanded somewhat radially and consequently assembly can be made easier or carried out with less production effort and/or energy consumption.

With the lamination proposed here, an element that carries magnets of a rotor of an electric rotating machine is presented, which element has a minimal tendency to produce imbalances and can be mounted in a simplified way.

List of reference signs

| | |
|---|---|
| 1 | Lamination |
| 2 | Pocket |
| 3 | Radial inside |
| 10 | First sector |
| 11 | First radius |
| 12 | Second radius |
| 13 | First window |
| 14 | Straight line |
| 20 | Transition area |
| 30 | Second sector |
| 31 | Third radius |
| 32 | Fourth radius |
| 33 | Elongate window |
| 34 | Bisecting line |
| 35 | Fifth radius |
| 36 | Sixth radius |
| 37 | Outer window |
| 38 | Delimiting line |
| 39 | Torque strut |
| 40 | Angle |
| 41 | Arc |
| 50 | Projection |
| 51 | Lug |
| 60 | Polygon |
| 61 | Rounded corners |
| 62 | Convex side |

1. A lamination of a laminated core of a rotor of an electric rotating machine, comprising:
a body having a ring shape defined by an inner radial side and an outer radial side;
a plurality of first sectors extending from the inner radial side to the outer radial side; and
a plurality of second sectors extending from the inner radial side to the outer radial side;
wherein a radial compressive strength of the plurality of first sectors, at least at the inner radial side, is greater than a radial compressive strength of the plurality of second sectors at the inner radial side .

2. The lamination according to claim 1, wherein in a first sector, on the inner radial side, a projection pointing radially inwards is arranged for abutment against an outer diameter of a shaft.

3. The lamination according to claim 1, wherein the inner radial side is delimited in the shape of a polygon .

4. The lamination according to claim 3, wherein respective corner areas of the polygon are located in respective first sectors.

5. The lamination according to claim 3, wherein the polygon has a triangular shape.

6. The lamination according to claims 1, wherein a first window is arranged in one first sector between a first radius and a second radius that is larger than the first radius, the first radius and the second radius being determined from an axis of rotatio n of the body.

7. The lamination according to claim 6, wherein two elongate windows are arranged at least partially in one second sector between a third radius and a fourth radius that is larger than the third radius, the third radius and the fourth radius being determined from the axis of rotation of the body .

8. The lamination according to claim 7, wherein an outer window is arranged in the one second sector on a bisecting line of the one second sector between a fifth radius and a sixth radius that is larger than the fifth radius, the fifth radius and the sixth radius being determined from the axis of rotation of the body.

9. A rotor of an electric rotating machine, comprising
a laminated core having a plurality of laminations arranged in a stacked manner and coaxially to an axis of rotation of a shaft of the electric rotating machine;
each lamination having a ring shape defined by an inner radial side and an outer radial side, each lamination including:
a plurality of first sectors extending from the inner radial side of the respective lamination to the outer radial side of the respective lamination; and
a plurality of second sectors extending from the inner radial side of the respective lamination to the outer radial side of the respective lamination:
wherein a radial compressive strength of the plurality of first sectors, at least at the inner radial side of the respective lamination, is greater than a radial compressive strength of the plurality of second sectors at the inner radial side of the respective lamination .

10. The rotor according to claim 9, wherein. at the inner radial side of the respective lamination. the second sector forms with the shaft i) an interference fit, or ii) a clearance fit.

11. The lamination according to claim 1, wherein the plurality of first sectors and the plurality of second sectors are arranged in an alternating manner about an axis of rotation of the body.

12. The lamination according to claim 3, wherein the polygon has at least one of rounded corners or convex sides.

13. The lamination according to claim 7, wherein the two elongate windows are arranged axisymmetric to a bisecting line of the second sector.

14. The lamination according to claim 7, wherein the two elongate windows extend, at least partially, into respective first sectors.

15. The lamination according to claim 7, wherein the third radius is smaller than the second radius and larger than the first radius.

16. The lamination according to claim 7, wherein the fourth radius is larger than the second radius.

17. The lamination according to claim 8, wherein the fifth radius is smaller than the fourth radius and larger than the third radius.

18. The lamination according to claim 1, wherein, at the inner radial side of the body, the first sector is configured to form an interference fit with a shaft.

19. The lamination according to claim 18, wherein, at the inner radial side of the body, the second sector is configured to form an interference fit or a clearance fit with the shaft.

20. The rotor according to claim 9, wherein, for each lamination, a first window is arranged in one first sector between a first radius and a second radius that is larger than the first radius, the first radius and the second radius being determined from the axis of rotation of the shaft.
